(19) United States
(12) Patent Application Publication
(10) Pub. No.: US 2024/0088696 A1
(43) Pub. Date: Mar. 14, 2024

(54) BURST CHARGING FOR AN ELECTROCHEMICAL DEVICE

(71) Applicant: Iontra Inc, Centennial, CO (US)

(72) Inventors: John Richard Howlett, III, Centennial, CO (US); Garrett P. Wheeler, Littleton, CO (US); Daniel A. Konopka, Denver, CO (US); Ryan Wu, Denver, CO (US)

(21) Appl. No.: 18/368,523

(22) Filed: Sep. 14, 2023

Related U.S. Application Data
(60) Provisional application No. 63/406,691, filed on Sep. 14, 2022.

(51) Int. Cl. H02J 7/00; H01M 10/44

(52) U.S. Cl. CPC H02J 7/00712; H01M 10/443; H02J 7/0047; H02J 7/007194

(57) ABSTRACT

Aspects of a charging system may involve altering the duty cycle of the shaped charge signal over a period of time to alter an average current supplied to an electrochemical device while maintain the maximum current of the charge signal. For example, the average current of the charge signal used to charge a battery may be adjusted by varying the duty cycle or peak current of the shaped charge signal, and may be based, in some instances, on the state of charge, temperature, and/or impedance of the battery. In some instances, control over the average or total current of the charge signal is constrained by the maximum current that the system can supply, such that altering the duty cycle of the charge signal provides control over an average current of the charge signal without needing to supply additional current sources.

### CROSS-REFERENCE TO RELATED APPLICATION

This application is related to and claims priority under 35 U.S.C. § 119(e) from U.S. Patent Application No. 63/406,691, filed Sep. 14, 2022, titled “Burst Charge,” the entire contents of which is incorporated herein by reference for all purposes.

### TECHNICAL FIELD

Embodiments of the present invention generally relate to systems and methods for charging a battery, and more specifically for the controlled sequencing of shaped charge signals to a battery.

### BACKGROUND

Countless different types of electrically powered devices, such as power tools, mobile computing and communication devices, portable electronic devices, and electrically powered vehicles of all sorts including scooters and bicycles, use rechargeable batteries as a source of operating power. Rechargeable batteries are limited by finite battery capacity and must be recharged upon depletion. Recharging a battery may be inconvenient as the powered device must often be stationary during the time required for recharging the battery. Depending on battery size, recharging can take hours. Moreover, battery charging is often accompanied by degradation of battery performance. As such, significant effort has been put into developing battery charging technology to reduce the time needed to recharge the battery, improve battery performance, and reduce degradation of the battery from charging, among other things.

It is with these observations in mind, among others, that various aspects of the present disclosure were conceived and developed.

### SUMMARY

One aspect of the present disclosure relates to a battery charging method. The method may include the operations of generating a series of charge signals, each charge signal at a period T and each charge signal including a shaped leading edge and a body portion delivering charge energy to a battery and altering a duty cycle of the charge signals to alter an average charge current delivered by the combination of the shaped leading edge and the body portion.

Another aspect of the present disclosure relates to a method for charging an electrochemical device. The method may include the operations of generating a charge signal comprising a shaped leading edge and a body portion delivering charge energy to a battery, the charge signal having a first duty cycle over a signal period T and corresponding to a first average current and altering, after a first period of time, the first duty cycle of the charge signal to a second duty cycle over the signal period T, the second duty cycle corresponding to a second average current of the charge signal, the second average current different than the first average current over the signal period T.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 is a schematic of an example charge signal generator arrangement for defining and generating the charging signal for a battery.

FIGS. 2-4 are illustrations of a charge signal for charging a battery with different duty cycles.

FIG. 5 is a signal graph illustrating utilizing constant average current of a charge signal to charge a battery.

FIG. 6 is a signal graph illustrating utilizing a varying a duty cycle of a charge signal to burst charge a battery.

FIG. 7 is a flowchart of a first method for managing average current by way of duty cycle alterations of a tuned charge signal.

FIG. 8 is a flowchart of a second method for managing average current by way of duty cycle alterations of a tuned/shaped charge signal.

FIG. 9 is a flowchart of a third method for managing average current by way of duty cycle alterations of a tuned/shaped charge signal.

FIG. 10 is a signal graph illustrating utilizing a controlled current and a controlled voltage of a charge signal to burst charge a battery.

FIG. 11 is a flowchart of a method of generating the shape for the charging portion of a signal involves obtaining an impedance spectrum for the battery.

FIG. 12 is a diagram illustrating an example of a computing system which may be used in implementing embodiments of the present disclosure.

### DETAILED DESCRIPTION

Systems, methods, and devices for charging a battery or battery system is disclosed herein. Moreover, aspects of the charging system may involve altering the duty cycle of the shaped charge signal over a period of time to alter an average current supplied to an electrochemical device while maintain the maximum current of the charge signal. For example, the average current of the charge signal used to charge a battery may be adjusted by varying the duty cycle or peak current of the shaped charge signal, and may be based, in some instances, on the state of charge, temperature, and/or impedance of the battery. In some instances, control over the average or total current of the charge signal is constrained by the maximum current that the system can supply, such that altering the duty cycle of the charge signal provides control over an average current of the charge signal without needing to supply additional current sources. In some specific instances, the average current of the charge signal may be controlled to “burst charge” a battery by supplying a relatively high average initial current in the charge signal (or after an initial period) and then reducing the average current over the charge cycle. Altering the duty cycle may include increasing the duty cycle to increase the average current of the charge signal or decreasing the duty cycle to decrease the average current. As mentioned, the duty cycle may be altered in response to any characteristic of the battery or the charge circuit. In some implementations, the average current of the charge signal may be adjusted by changing the period of the charge signal. Further, the duration of the burst charge may be dependent on the type of battery or battery system being charged as different cell chemistries may react to a burst charge differently.

In one example, the various embodiments discussed herein charge a battery by generating a charge signal that is controllably shaped by a charge signal shaping circuit. Conventional charge techniques, like constant current constant voltage (CCCV), do not involve charge signal shaping and may include frequencies or harmonics that degrade the battery performance over time, in addition to being inefficient in charging the battery. Aspects of the present disclosure, therefore, may include a shaped charge signal corresponding to a harmonic (or harmonics) associated with an efficient transfer of energy to the battery. In some instances, the charge signal shaping circuit may include a controller generating control signals to the components of the charge signal shaping circuit to shape or otherwise alter a charge signal. Said controller may include, in some implementations, a model of one or more components of a charge signal shaping circuit. The model may be used to confirm and/or adjust the controls for generating the signal based on an expected or intended charge signal for charging a battery.

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery, increasing the available power of the battery with each stacked unit. Although many examples are discussed herein as applicable to a battery, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of lithium batteries including but not limited to lithium-metal and lithium-ion batteries, lead-acid batteries, various types of nickel batteries, and solid-state batteries of various possible chemistries, to name a few. The various implementations discussed herein may also apply to different structural battery arrangements such as button or “coin” type batteries, cylindrical battery cells, pouch battery cells, and prismatic battery cells.

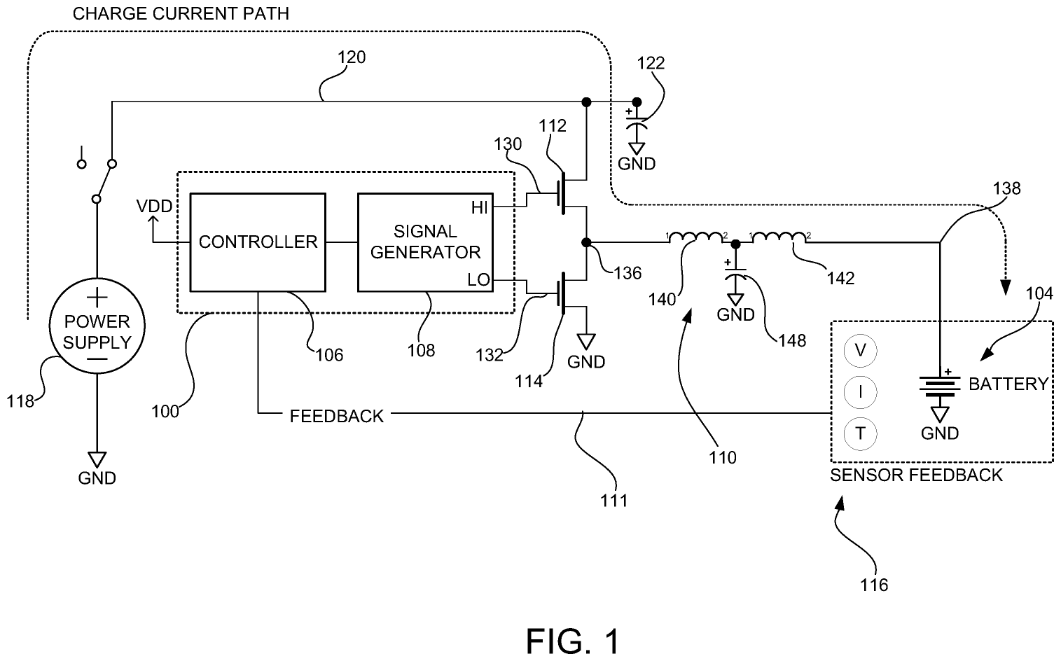

FIG. 1 illustrates a battery charging circuit topology in accordance with one embodiment of the present disclosure. In FIG. 1, the system is shown in a configuration sourcing current (charging) the battery. The circuit may also be operated to power a load, only charge the battery, or power a load and charge the battery. The system, as shown, includes an example charge signal generator arrangement 100 for defining and generating the charging signal for a battery 104. The generator 100 includes a processing unit or more generally a control unit that may include a controller 106, such as a microcontroller, FPGA (field-programmable gate array), ASIC (application-specific integrated circuit), microprocessor, combinations thereof, or other processing arrangement, which may be in communication with a signal generator 108 that produces controls for generating a charge signal from a charge signal shaping circuit 110. In some instances, the controller 106 may be in communication with a model, which may be part of the generator 108, to produce the control instructions to the charge signal shaping circuit 110. The control unit, including the controller and a model if present, may be an integrated unit.

The system may also receive feedback 111 including battery measurements from a battery measurement unit 116, such as current, voltage, and/or temperature at battery terminals or at the battery more generally. Such battery measurements may be used to obtain impedance, state of charge, or other possible battery parameters or characteristics. In addition, the system may also include or be operably coupled with a power source 118, which may be a voltage source or a current source. In one embodiment, the power source 118 is a direct current (DC) current or voltage source, although alternating current (AC) sources are also contemplated. In various alternatives, the power source 118 may include a DC source providing a unidirectional current, an AC source providing a bidirectional current, or a power source providing a ripple current (such as an AC signal with a DC bias to cause the current to be unidirectional). In general, the power source 118 supplies the charge energy, e.g., current, that may be shaped or otherwise defined by the controller 106 and circuit 110 to produce a controllably shaped charge signal to charge and/or otherwise be applied to the battery 104. In one example, a controller 106 may provide one or more inputs to the signal generator 108, which controls switches to generate pulses to the circuit 110, which may also be referred to as a filter, which produces the shaped signal at the battery.

In some instances, the signal shaping circuit 110 may alter energy from the power source 118 to generate a signal that is shaped based on conditions at the battery 104, such as a signal that at least partially corresponds to a harmonic or harmonics based on the impedance when a signal comprising the harmonic or attributes of the harmonic is applied to the battery 104. In the example of FIG. 1 and otherwise, the circuit 100 may include the battery measurement unit 116 connected to the battery 104 to measure cell voltage and/or charge current, as well as other battery attributes like temperature and measure, calculate or otherwise obtain the impedance the battery 104, among other characteristics, in the presence of the charge signal. In one example, battery characteristics may be measured based on the signal to or from the battery. In another example, battery cell characteristics may be measured as part of a routine that applies a signal with varying frequency attributes to generate a range of battery cell characteristic values associated with the different frequency attributes to characterize the battery, which may be done prior to charging or otherwise managing energy to or from the battery, during charging, periodically during the same, and may be used in combination with look-up techniques, and other techniques. The battery characteristics may vary based on many physical of chemical features of the battery, including a state of charge and/or a temperature of the battery. As such, the battery measurement circuit 116 may be controlled by the controller 106 to determine various battery characteristic values of the battery 104 during recharging of the battery and provide the measured battery characteristic values to the controller 106 or other parts of the generator 100.

During charge, the controller 106 may generate an intended charge signal for efficient charging of the battery 104. For example, a determined impedance of the battery 104 or signal definitions characterized from understanding impedance effects of signals on a battery may be used by the controller 106 to generate or select a charge signal with attributes that correspond to a harmonic associated with an optimal impedance, which may be a range of impedances, for energy transfer, which optimal impedance may be associated with a minimum impedance value of the battery 104. As such, the controller 106 may execute a charge signal algorithm that outputs a charge signal shape based on measured, characterized and/or estimated charging conditions of the battery 104. Generally speaking, the signal generator controls the switches to generate a sequence of pulses at node 136, which are converted by circuit 110 to the charge signal shape. The control signals may, among other functions, shape or otherwise define the signal to the battery to approximate the shaped charge signal determined, selected or otherwise obtained by the controller 106. The charge signal shaping circuit 110 may further filter any unwanted frequency attributes from the signal. In some instances, the shaped charge signal may be any arbitrarily shaped signal, such that the signal, is not a constant DC signal and does not conform to a conventional repeating charge signal, such as a repeating square wave or triangle wave charge signal.

The circuit of FIG. 1 includes switching elements 112, 114, which may be considered part of circuit 110, to generate an initial sequence of controlled pulses at node 136, which are then converted into a shaped signal by filter 110, to produce a signal to the battery, in accordance with one embodiment. The switching elements may also be used to generate a discharge signal from the battery by similarly generated pulses at node 136, without the presence of charge current on the rail 120.

The circuit 100 may include a first switching element, e.g., transistor 112, and a second switching element, e.g., transistor 114, with the first switching element connected to the power rail and thereby connected to the power supply 118. Power may also be delivered from a capacitor 122, in some instances. The capacitor 122, which may also be referred to as a tank capacitor, is a local energy storage nearer to the battery 104 relative to the power source to reduce the series resistance in provided energy to charge the battery. In some implementations, charge current may come from the power supply 118, the tank capacitor 122, or a combination of the power supply and the tank capacitor. Because there is a series resistance that is higher between the load (battery) 104 and the power supply 118 as compared to between the load and the capacitor 122, the initial majority of the charge current comes from the capacitor. Once the capacitor 122 is depleted, however, any additional current may come from the power supply 118. The presence of the tank capacitor 122 may also enhance voltage stability, which is useful in predictably shaping the charge signal, among other advantages. As will be apparent from the various charge waveforms discussed in more detail below, because charge energy delivery to the battery 104 may be altered by controlling the duty cycle of charge signals, which may include a rest period between active charge signals, the tank capacitor 122 may recharge during these rest periods.

The first transistor 112 may receive an input signal, such as pulse-width modulation (PWM) control signal 130, to operate the first transistor 112 as a switching device or component. In general, the first transistor 112 may be any type of transistor, e.g., a FET or more particularly a MOSFET, a GaN FET, Silicon Carbide based FETs, or any type of controllable switching element suitable for operating at the power levels of any given use case or implementation. For example, the first transistor 112 may be a FET with a drain node connected to a first inductor 140, a source connected to the rail, and a gate receiving the control signal 130 from the signal generator 110. In various embodiments, the circuit 110 also includes the inductor 140, but may also have various other possible inductive elements.

For sourcing current (charging), the control signal 130 may be provided by the circuit controller 106 to control the operation of the first transistor 112 as a switch that, when closed, connects the first inductor 140 to the rail 120 such that a current from the power supply (and/or sourced from capacitor 122) flows through the first inductor 140, as well as a second inductor 142 if present, to the battery. The second transistor 114 may receive a second input signal 132 and may also be connected to the drain of the first transistor 112 at node 136. In a charge situation and in some instances, the second input signal 132 may be a PWM signal opposite of the first control signal 130 to the first transistor 112 such that switching is coordinated with one switch on while the other switch is off.

The inductor value or values, the capacitor value or values, the time and frequency of actuating the transistors, and other factors can be tailored to generate a waveform and particularly a waveform with controlled shaping commensurate with some understanding of the impedance effect of certain harmonics or, more generally, frequency at the battery. In addition, the shaped signals may be operated or otherwise controlled based on a duty cycle. During control of the charge circuit, the combination of factors defining a charge signal may be controlled to change the average current of the charge signal. For example, the average current of the charge signal used to charge the battery 104 may be adjusted by varying the duty cycle or peak current of the shaped charge signal, and may be based, in some instances, on the state of charge, temperature, and/or impedance of the battery. In some instances, control over the average or total current of the charge signal is constrained by the maximum current that the system can supply, perhaps due to a cost constraint, infrastructure (outlet power limits), or other factors.

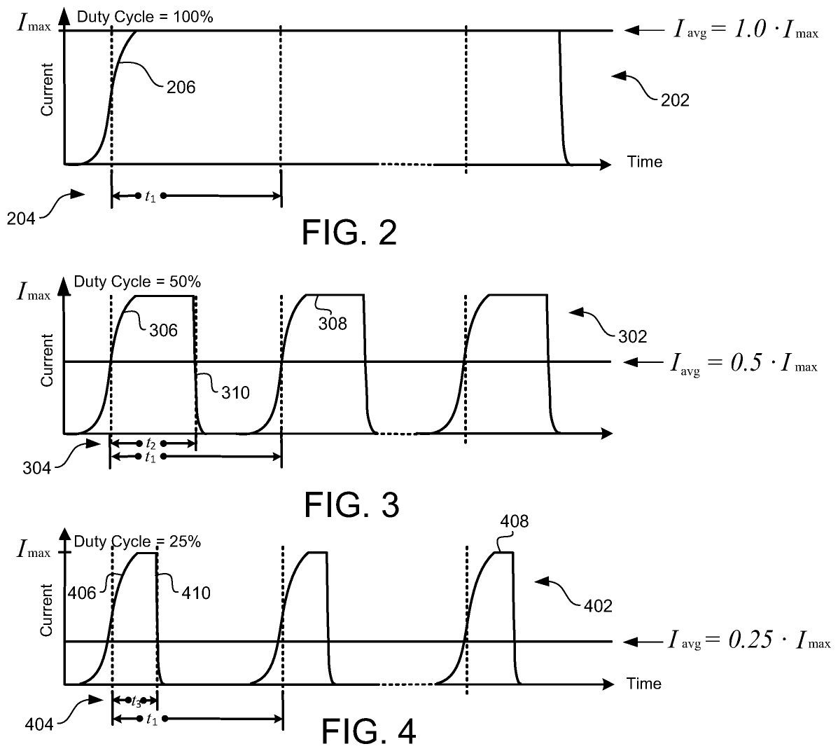

With reference to the example signals illustrated in FIGS. 2-4, the signal at node 136 when sourcing current (and in response to the control signal provided to transistor 112 and, in some cases, transistor 114) may be a series of pulses between 0 volts and about the rail voltage at rail 120. The pulses at node 136 may be of a varying duty cycle and may be generated at a varying frequency. The duty cycle of the pulses at the node 136 to produce a shaped signal should not be confused with the duty cycle of the charge signal itself. Overall, the pulses are generated to produce a signal that is the same or nearly the same as the intended current signal to (or from) the battery. So, for example, a signal like any of those in FIGS. 2-4 would be at node 138 based on the combination of pulses present at node 136, which are then shaped into the signal at 138 by the filter arrangement 110. Depending on the signal, tens to thousands (or more) of pulses may be generated to form the desired charge signal.

FIG. 2 illustrates an example charge signal 202 with a 100% duty cycle over a period t₁ 204. The charge signal 202 is considered to have a 100% duty cycle as the charge signal is active over the entire period t₁ 204. In the example illustrated in FIGS. 2-4, period t 1 may correspond to an inflection point of leading edge sinusoid of a first pulse of the charge signal to a corresponding inflection point of a leading edge of a next pulse of the charge signal. This point may be selected as the beginning of the period t₁ as the area under the curve of the charge signal prior to the inflection point may be similar to the area above the curve following the inflection point up to the body portion of the signal. Thus, a more accurate duty cycle estimation of the charge signal may be determined by setting the beginning of the period t₁ as the inflection point of the leading edge sinusoid. In other examples, the period may be measured from any point on the charge signal. In various examples, the period t₁ may be in the range of milliseconds to seconds. In this case, the leading edge 206 of the signal 202 is shaped to define a portion of a sinusoid at a frequency or an approximation thereof. In some instances, the sinusoid may be associated with an impedance of the battery 104. FIG. 3, by comparison, illustrates an example charge signal 302 with a 50% duty cycle over the same period t₁ 204. In this example, the leading edge 306 of the signal 302 is shaped, like in FIG. 2, although a body 308 of the signal, at a relatively constant current for the a time period slightly less than t₂ is relatively shorter, with a trailing edge 310 (after period t₂ 304) returning the charge signal from the constant current of the body to some lesser value that may be 0 amps for a rest period at about half of period t₁ 204. As should be appreciated, the maximum current during the rest period is less than a maximum current during the body portion 308. The signal may then repeat at the same or a different duty cycle as determined by the controller 106. FIG. 4 illustrates an example charge signal 402 with a 25% duty cycle over the same period t₁ 204. In this example, the leading edge 406 of the signal 402 is shaped like the signals in FIGS. 2 and 3, and a body 408 of the signal is shorter (over period t₃ 404) given the lesser duty cycle and the rest period following the trailing edge is relatively longer.

The signal graphs illustrated in FIGS. 2-4 illustrate how reducing the duration at which the charge signal is held at the maximum current (Iₘₐₓ) in differing duty cycles can change the average current (I_{avg}) being delivered in a charge. Note that maximum current may be a function of many aspects of the circuit and/or the charge signal, such as the power supply, tank capacitors (such as capacitor 122), duty cycle, and signal period. Thus, a signal with a short period and a low duty cycle can produce higher Iₘₐₓ current than a system with the same duty cycle and longer period if the tank capacitor and power supply remain fixed. As such, for the example set of graphs illustrated in FIGS. 2-4, the period and Iₘₐₓ remain fixed while the duty cycle varies to simplify the concept of how varying the duty cycle results in a lower average current.

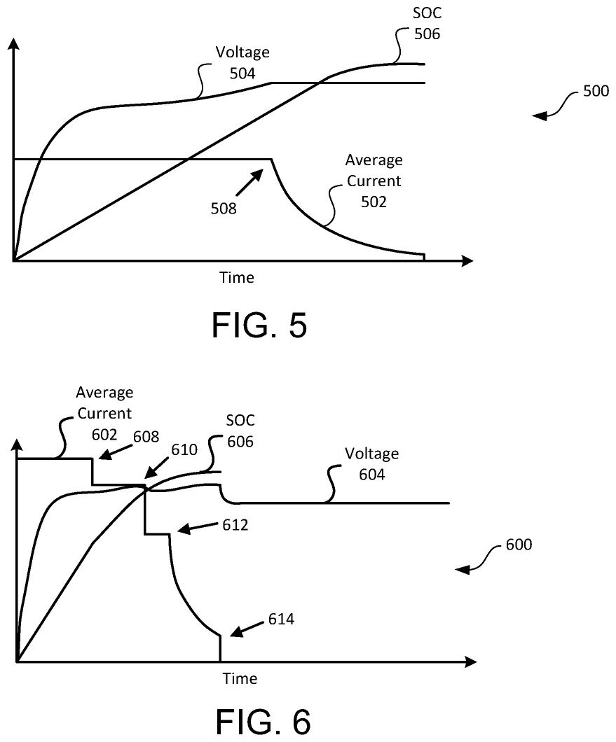

FIG. 5 is a graph illustrating a first example of controlling an average current of a charge signal with a fixed period, duty cycle, and Iₘₐₓ until the average/target voltage of the battery is reached. A state of charge of the battery being charged is also illustrated in the graph. In particular, the graph 500 illustrates a plot of the average current 502 of the charge signal, the voltage 504 of the charge signal, and the state of charge 506 of the battery. In this example, the average current 502 of the charge signal may be maintained at a constant value as the voltage 504 and the state of charge 506 of the battery increases until the battery is fully charged. After the battery has been charged for a certain amount of time (denoted by arrow 508), the system may alter some aspect of the charge signal (such as the duty cycle, period, and/or Iₘₐₓ) to reduce the average current to maintain the target voltage. Point 508 may be based on any characteristic of the battery, such as the state of charge. Point 508 may also be based on the voltage 504 of the charge signal such that, when the voltage reaches a target value. To maintain the voltage at the target value, the above characteristics may be adjusted by the controller 106 or other component of the charge circuit. For example, rather than simply reducing the current of the charge signal, the system may reduce the average or max current by altering the duty cycle or period of the charge signal. This allows the system to continue to inject charge current using an advantageously harmonically shaped charge signal and rest periods. This approach also allows for reducing current at some point (such as point 508) to continue to optimize other aspects of the battery like longevity, heat and the like, while charging at relatively higher rates than would be possible with conventional DC charging without damaging the battery.

FIG. 6 illustrates a graph 600 of a second example varying the duty cycle to affect a burst charge approach to quickly charge the battery. In this example, the duty cycle of the charge signal may be controlled starting at 100% and stepping it down at various times, indicated by arrows 608-614, while keeping the Iₘₐₓ and period constant. In this example, the average current into the battery is reduced by successively stepping down the duty cycle at the noted times. In general, the duty cycle step-downs may be initiated based on any characteristic of the battery and/or charge circuit, such as state of charge level 606, voltage level 604, and/or temperature of the battery.

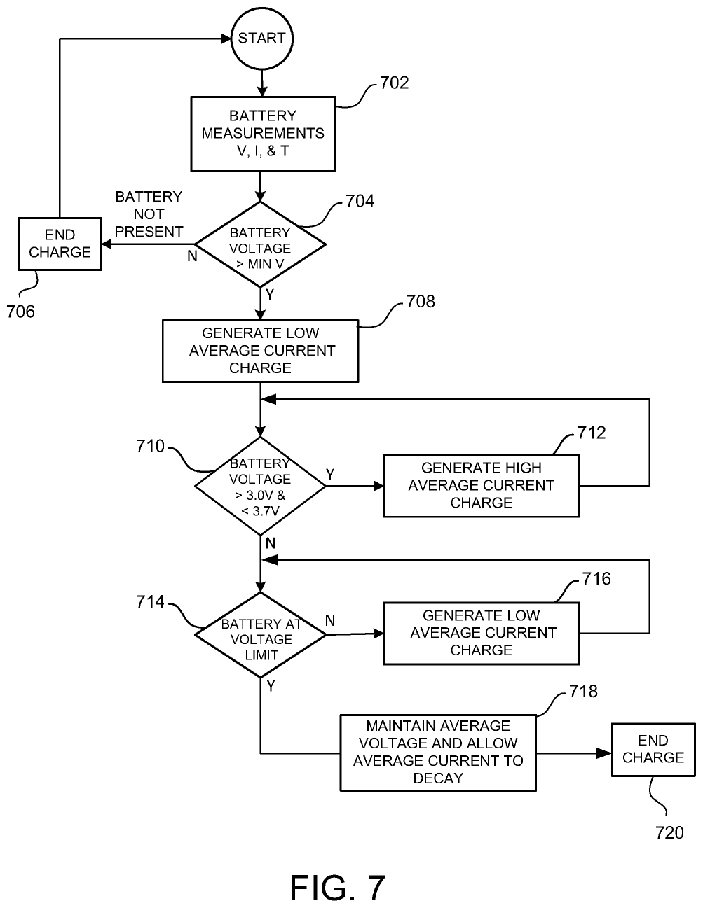

FIG. 7 is a flowchart depicting a method for managing average current of a tuned charge signal by way of duty cycle alterations. The operations of the method 700 may be performed by any portion of the charge circuit of FIG. 1 and, in some particular implementations, the controller 106. As explained in more detail below, the controller 106 may utilize components or measurements of the circuit of FIG. 1 to aid in adjusting the duty cycle of the charge signal to implement charging of a battery.

In this example, measurements of characteristics of the battery 104 may be measured at step 702, such as by sensor feedback 116. Such measurements may include a voltage across the battery, a current into the battery, a temperature of the battery, and the like. At step 704, it is determined if the battery voltage is greater than a minimum voltage value, such as zero. If not, the battery 104 may not be present or otherwise connected to the charge circuit and no charge signal may be generated at step 706. At step 708, a low average current may be applied to the battery charging signal to charge the battery 104. In some instances, The low average current may be based on the battery being charged. For example, the low average current generated at step 708 may be around 5 amps for an M35A cell or 8 amps for a 30T cell. In general, the low average current may be any amount and, in some instances, based on the type of battery being charged. In one example, a charge signal may be controlled to have a low duty cycle that corresponds to the desired average current for charging the battery during this first period of time. The terminal voltage of the battery 104 may continue to be monitored at step 710 and, at a first voltage value (e.g., 3.0 volts for an example lithium-ion cell), the battery cell is charged with a relatively higher average current at step 712. This higher average current of the charge signal may be controlled through increasing the duty cycle of the charge signal. Between the first voltage and a second voltage (e.g., 3.7 volts in the example cell), the battery 104 is charged at the relatively higher average current (e.g., a relatively higher duty cycle). At step 714, it may be determined if the battery 104 is charged to a voltage limit (such as 4.2 volts) and, if not, the system transitions back to a lower average current at step 716. Once the voltage limit is reached, the average voltage of the charge signal may be maintained as the average current is allowed to decay at step 718 until the end of the charge cycle at step 720. In one example, at the triggering threshold voltage limit, the system maintains the battery at the voltage limit by actively lowering the current (e.g., actively lowering the average current) while assessing the measured voltage against the threshold voltage limit. Toward the end of charge, if the current is maintained at its value, the terminal voltage will begin to rise and exceed the voltage limit. As such, to maintain the voltage at the voltage limit, the battery voltage may be measured and the average current decreased to counteract what would otherwise be a rising voltage if the current were not reduced. This may be done until an end of charge condition, like some minimum lower average current, upon reaching 100% SOC, based on time, or otherwise. The end of charge 720 may occur based on any characteristic of the battery, such as a 100% SOC or until the average current decays to some threshold value (such as 0.5 amps or some other value, perhaps based on the type of battery cell being charged). The switching of high average current to low average current may provide significant advantages over traditional charging techniques. In particular, in many cases impedance at the battery 104 may be higher at lower voltages, and thus, a lower average current used at various times during the charging process, such as during an initial portion of the charge cycle when the battery voltage is at its lowest. This would be in contrast to many techniques where it is often decided that a higher current is to be used at lower voltages.

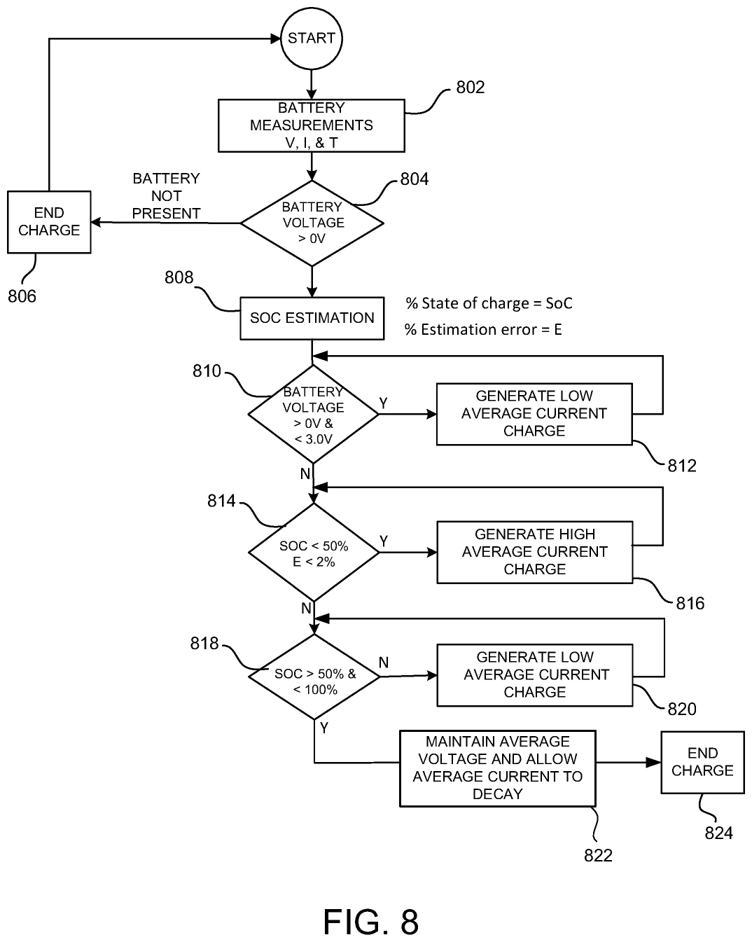

FIG. 8 is a flowchart depicting a second method for managing average current of a tuned charge signal by way of duty cycle alterations (and/or period, like the method of FIG. 7). Similar to above, the operations of the method 800 may be performed by any portion of the charge circuit of FIG. 1 and, in some particular implementations, the controller 106. As explained in more detail below, the controller 106 may utilize components or measurements of the circuit of FIG. 1 to aid in adjusting the duty cycle of the charge signal to implement charging of a battery.

In this example, measurements of characteristics of the battery 104 may be measured at step 802 and, as above, it may be determined if the battery voltage is greater than zero at step 804. If not, the battery 104 may not be present or otherwise connected to the charge circuit and no charge signal may be generated at step 806. At step 808, a state of charge (SOC) of the battery and an estimated error in the determined SOC may be determined. In one example, the SOC may be estimated through a coulomb counting technique in which a discharge current of the battery is measured and integrated over time to estimate the SOC. In another example, an SOC estimator utilizing a Kalman filter may be used in the circuit. In general, however, other techniques for estimating an SOC of a battery may be utilized by the charge systems discussed herein, such as techniques that utilize a voltage of the battery and/or state of age of the battery. An estimated error of the SOC may be determined through similar techniques, such as the Kalman filter technique, that compares a determined SOC to a prior estimated SOC value. In another example, a determined SOC may be compared to an estimated SOC through another technique, such as an open circuit voltage technique or by using a look-up table to expected SOC values. In general, any known technique may be used to estimate an error in a determined SOC of the battery.

The method may initially use a battery voltage threshold like the method of FIG. 7 to determine the average current for the charge signal. Thus, at step 810, the battery voltage may be determined to be between 0 volts and some threshold value (such as 3.0 volts, although any threshold value may be used). During this period of charging, a low average current may be applied to the battery charging signal to charge the battery 104. In one example, a charge signal may be controlled to have a low duty cycle that corresponds to the desired average current for charging the battery during this first period of time. In another example, the period of the charge signal may be controlled to provide a relatively low average current charge signal.

At step 814, the system may assess a state of charge of the battery 104 and trigger a higher average current at step 816 until a threshold state of charge (e.g., 50% is reached). The method also may assess error in the state of charge assessment, and act when the error is below some value (e.g., 2%), which may also impact the SOC threshold. Above the threshold SOC and until the battery is charged, the system may return to a lower average current charge by reducing the duty cycle or adjusting the period of the charge signal. In particular, at step 818, system may determine that the SOC of the battery 104 is between 50% and 100% and generate a low average current charge signal at step 820. Once the SOC is estimated to be 100%, or more likely some value less than 100% SOC (e.g., between 95% and 99%), the average voltage of the charge signal may be maintained as the average current is allowed to decay at step 822 until the end of the charge cycle at step 824. In one example, at the triggering SOC, the system maintains the threshold voltage by actively lowering the current while assessing the voltage against the threshold voltage. Lowering of the current may be achieved by lowering the average current, and the various techniques discussed with regard to FIGS. 2-4 and otherwise herein. Toward the end of charge, if the current is maintained at its value, the terminal voltage will begin to rise. As such, to maintain the voltage at the threshold voltage, the battery voltage may be measured, and the average current decreased to counteract what would otherwise be a rising voltage if the current were not reduced. This may be done until an end of charge condition, like some minimum lower average current, upon reaching 100% SOC, or otherwise.

It should be recognized that thresholds of battery voltage, state of charge (including or not including error) and other factors, e.g., battery temperature, may be involved in setting the duty cycle and determining when to alter the duty cycle. In some instances, the system may begin with a set duty cycle reflective of the average current intended at any initial battery voltage, state of charge, and/or temperature, or otherwise. Adjustments may then proceed based on any of the factors discussed herein to adjust the average current of the charge signal generated by the charging circuit.

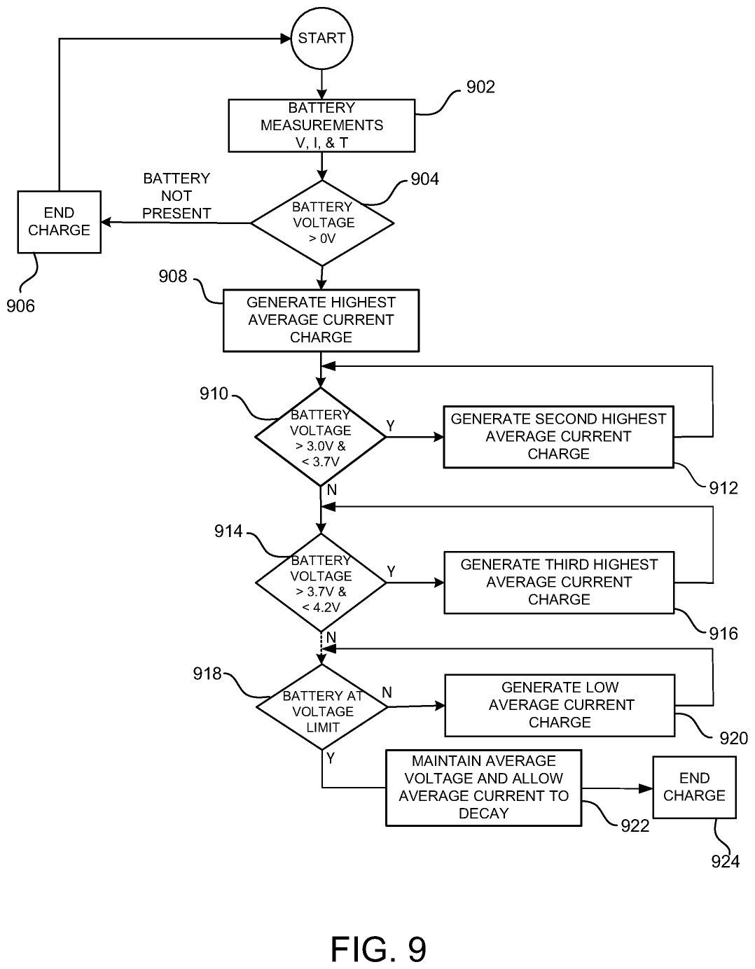

FIG. 9 is a flowchart depicting a third method for managing average current of a tuned charge signal by way of duty cycle alterations. In this method, the average current of the charge signal may start at a high average current and step-down, through duty cycle and/or period control, during the charge cycle, such as that depicted in the graph 600 of FIG. 6. The step-down of the average current may be based on any characteristic of the charge signal or the components of the charge circuit. For example, the step-down of the average current may be based on characteristics of the battery 104, such as voltage and/or state of charge. Thus, although described with relation to stepping down the average current based on a voltage of the battery, any other characteristic of the battery 104 may be used as the threshold values at which the average current is adjusted. Further, the adjustment to the average current may include adjusting a duty cycle of the charge signal, a period of the charge signal, or any other aspect of the charge signal or circuit as discussed herein.

In the example method of FIG. 9, measurements of characteristics of the battery 104 may be measured at step 902, such as a voltage across the battery, a current into the battery, a temperature of the battery, and the like. At step 904, it is determined if the battery voltage is greater than zero and, if not, the battery 104 may not be present or otherwise connected to the charge circuit and no charge signal may be generated at step 906. If the battery 104 is present, a charge signal with a high average current may be applied to the battery charging signal to charge the battery 104 at step 908. In some instances, this highest average current may be applied after an initial period in which the voltage of the battery is increased to avoid a low-voltage, high-impedance charging of the battery. The average current applied to the battery 104 during this period may be the highest average current of the charge signal during this charging period. The terminal voltage of the battery 104 may continue to be monitored at step 910 and, when the battery voltage achieves a first voltage threshold value (e.g., 3.0 volts for an example lithium-ion cell), the average current of the charge signal may be lowered to a second highest average current at step 912. In one implementation, this second higher average current of the charge signal may be controlled through adjusting the duty cycle of the charge signal.

Between the first voltage threshold and a second voltage threshold (e.g., 3.7 volts in the example cell), the battery 104 is charged at the second highest average current. Similarly, the terminal voltage of the battery 104 may continue to be monitored at step 914 and, when the battery voltage achieves the second voltage threshold value (e.g., 3.7), the average current of the charge signal may again be lowered to a third highest average current at step 916. This step-down of the average current of the charge signal may continue through any number of threshold values of a characteristic of the battery and/or the charge circuit. Eventually, at step 918, it may be determined if the battery 104 is above a fourth voltage threshold value (such as 4.2 or 4.5 volts) but not yet fully charged. If so, the charge signal may be adjusted to generate a low average current relative to the previous charge signals at step 920. Once the battery is charged to a voltage limit (such as 4.2 volts), the average voltage of the charge signal may be maintained as the average current is allowed to decay at step 922 until the end of the charge cycle at step 924. End of charge may be managed as discussed above with regard to the methods of FIGS. 7 and 8. So, for example, the average charge current may be actively reduced to maintain a voltage limit and continuously reduced until an end of charge condition is reached. It should be noted that variations in the average current may occur within any of the steps described above. For example, the low average current of step 920 may not be a maintained average current for the period of time, but may be an average current that responds to a constant voltage of the charge signal, such as illustrated in FIG. 6 between time 612 and time 614. Periods of charge signal control in which a constant voltage is used rather than a constant average current is discussed in more detail below.

As mentioned, threshold values at which the average current is adjusted may be based on the battery cell type. For example, an M35A type battery cell may have an initial average current of 8.7 amps (with a 10.2 amps peak current) until a 40% SOC is reached. The average current may then be stepped down to 7.4 amps (with a 8.7 amps peak current) until 70% SOC of the battery is reached, at which point the average current may be adjusted down to 5.4 amps (peak current of 6.3 amps) until the end of the charge cycle. The average current of the charge signal may be adjusted to such values through a change in the duty cycle and/or period of the signal. In another example, a 30T type battery cell may have an initial average current of 12.2 amps (with a 16.5 amps peak current) until battery voltage of 3.9 volts is reached. The average current may then be stepped down to 8.0 amps (with a 10.8 amps peak current) until the end of the charge cycle. The battery types and threshold values provided herein are merely examples of how the various threshold values may be adjusted or altered to charge different types of battery cells.

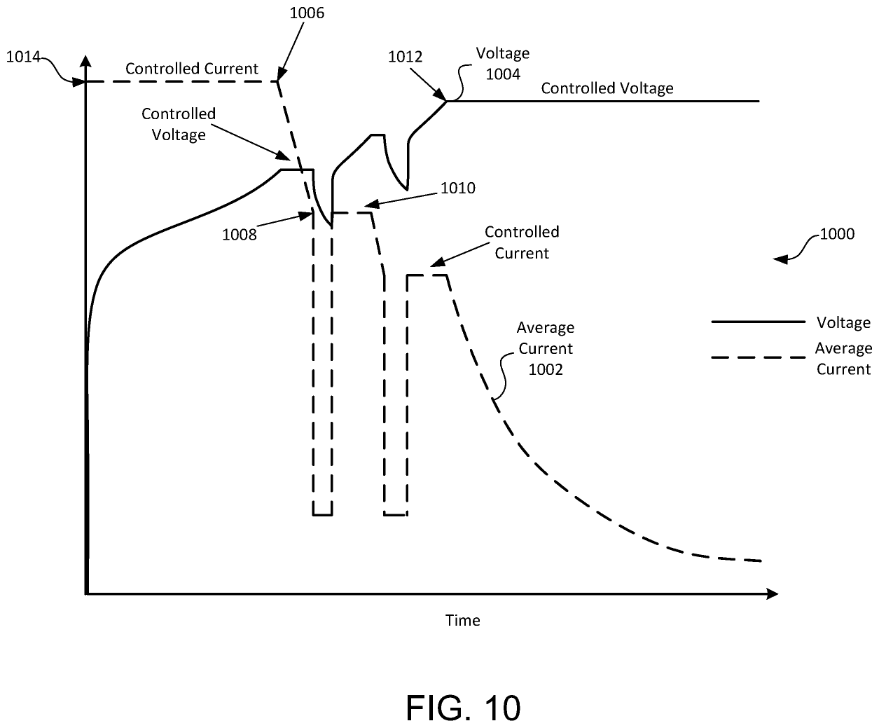

FIG. 10 a graph 1000 of another example of a variable average current of a charge signal to charge a battery 104 over time, with the average current 1002 and the voltage 1004 of the charge signal illustrated in the graph. As above, the average current 1002 may be adjusted during charging by varying the duty cycle and/or a period of the charge signal. Similar to the burst charge technique discussed above with relation to FIG. 6, the duty cycle of the charge signal may be controlled starting at or near 100% at the beginning of the charge cycle to provide the most current to the battery 104 during the initial charge portion. As the average current of the charge signal is being controlled, this period is considered a controlled current period of the charge signal. However, at time 1006, the voltage of the charge signal may controlled (perhaps by controller 106) to be constant for a second period of time. During this second period of time, the average current 1002 of the charge signal is controllably decreased to hold the voltage at a constant voltage.

At time 1008, the duty cycle of the charge signal may be controlled to cause a rest period of less average current in the charge signal. The “drop-out” period may be provided in the charge current to allow a temperature of the battery to decrease so as to not overheat the battery 104. As high temperatures may damage a battery and applying a charge signal to the battery may increase the battery temperature, removing the charge signal from the battery for a cooling period may prolong the life of the battery 104. The duration of the cooling period may be dependent on many characteristics of the battery 104, including stored information of the battery and/or measured characteristics. Further, the cooling period may be triggered based on any aspect of the charge signal and/or components of the circuit, such as time under charge, measured or derived temperature of the battery, voltage of the battery, impedance, etc.

Following the cooling period, the charge signal may again be adjusted to provide a controlled average current, such as at period 1010. The controlled average current during this period may be less than the initial average current 1014 of the charge signal, such that the average current has stepped down, as described above. This pattern of controlling the average current through a duty cycle control with periods of controlled voltage and cooling periods may be repeated any number of times and may be triggered or based on any characteristic of the charge signal and/or the charge circuit. At some point, such as time 1012, the voltage of the charge signal may be controlled at a level, while controllably reducing the average current 1002 down to some level where the battery is considered fully charged. The controlled voltage 1004 period may continue until the battery achieves a full charge or the end of the charge cycle occurs. In this manner, a combination of a controlled constant voltage and a controlled constant average current, through duty cycle control of charge sequences, may be implemented in the charge signal to charge the battery 104. In addition, one or more cooling periods may be implemented to allow the temperature of the battery to be maintained, stop or slow increasing, and/or decrease during charging. For example, if the temperature is rising at a rate that will cause it to exceed some threshold during a charge sequence, one or more drop out periods may be implemented so that the battery is fully charged without exceeding a temperature threshold. The charging techniques described herein may improve the efficiency and speed at which a battery is charged, while reducing damage to the battery due to high current charging.

As noted herein, a charging signal may include a shaped leading edge, a body portion and a rest period. The described charging technique and charging signal is not a conventional constant current constant voltage type charging where, in essence, a specified constant charge current is applied until the battery voltage begins to rise, at which time the charge current is reduced. Rather, the charge signal is described with relation to an average current that is supplied to the battery 104 through the combination of the shaped leading-edge signals and an overall duty cycle of the body portion and rest period, if any. The charging technique is also not pulse charging as the charge signal defines a specifically shaped leading edge; in fact, high frequency harmonic content square pulses are typically avoided for charging due at least to high impedance to the uncontrolled high frequency harmonic content of square pulses, particularly when the pulse first initiates.

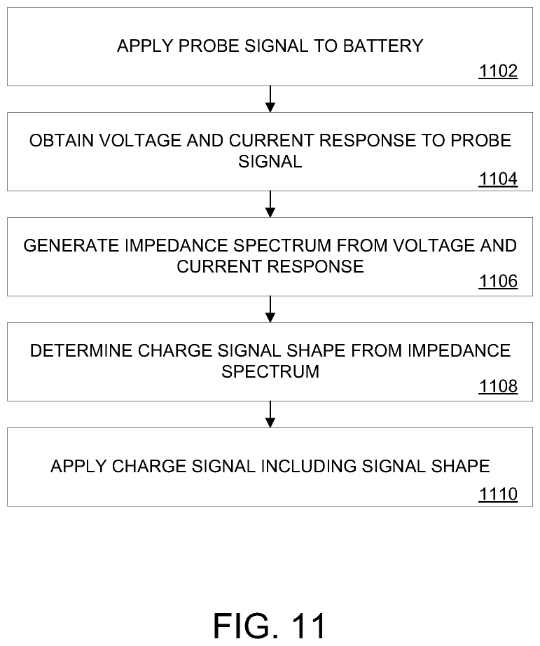

Turning now to FIG. 11, a method of generating the shape for the charging portion of a signal involves obtaining an impedance spectrum for the battery, and from the impedance spectrum selecting a frequency at which the impedance is relatively low and using that frequency to define the shaped-leading edge of the charge portion of a signal. In one example, the system uses or otherwise references imaginary impedance (reactance) values. The shaped leading edge and overall signal may be generated using the circuits depicted in FIG. 1 and otherwise. The harmonic content may be obtained in real-time or through characterization of a cell over various numbers of cycle and charging conditions, including temperature and state of charge, where the leading edge shape may also be tuned in real-time or preprogrammed based on characterization.

To obtain an impedance spectrum, in one possible example, the method involves applying a probe signal to the battery (operation 1102). The probe signal may include a spectrum of harmonics, which may be used by the system to assess the impedance of the battery to the various harmonics. The probe signal may be the charge signal or may be a dedicated signal. The probe signal may be interleaved during charging or run discretely at the start of charge or otherwise. In one example, the probe signal may be square wave or square pulse. In one specific example, the probe signal is a square wave centered at zero amps. In one possible example, the probe signal is a square wave centered at zero amps, with a +4 V (positive) portion and a −4 V (negative) portion. Here, the mean current is 0 A. The duty cycle is 50%. The frequency, duty cycle, current or voltage magnitude or other attributes of a probe signal may vary depending on cell type, device type, temperature, state of charge and other possible parameters. These parameters may be determined based on characterization of any given cell type. In one specific example, the square wave probe is applied to the battery for a single period of about 30 msec. Stated differently, the probing signal may comprise a positive square pulse of some current and a negative square pulse of some current. The pulses may have the same duration, e.g., 15 msec each, or may have different durations. A probe signal may be only a positive pulse (current to the battery) or only a negative pulse (discharge current from the battery). Each pulse may include the same magnitude current or the pulses may be asymmetric. While other probing signals are possible, a square pulse or wave has harmonic content at a wide range of frequencies and is efficiently generated by a range of conventional charging hardware topologies, which may also be used to produce the heating signals and shaped charging signals discussed herein. In general, the purpose of the probe signal is to very briefly and discretely introduce a wide spectrum of harmonic content into the battery in order to assess the impedance of the battery to various harmonics. Thus, whether a square wave or square pulses or other signals, the probe signal is intended to introduce, momentarily, a spectrum of harmonics to the battery. In the case of a square wave centered at zero amps, there may also be an equal magnitude current to and from the battery with little or no net charge effect. In some arrangements, it is possible to inject a range of different probes, containing different harmonic content. Even though uncontrolled and/or high frequency harmonics may have deleterious effects on the battery, the system is only applying the square pulses in a very short duration for the purpose of obtaining the impedance spectrum thereby substantially avoiding such effects.

In the presence of the probe signal, the system measures the current and the voltage at the battery terminals (operation 1104). The current and voltage signals are captured in the time domain. For each of the current and voltages measured in the presence of the probe signal, the system obtains a frequency spectrum from which the system may further generate an impedance spectrum (operation 1106). In one example, the system generates domain transforms of the current and voltages signals to produce a voltage frequency spectrum and a current frequency spectrum. The domain transform may be a discrete Wavelet transform using a Morlet wavelet. In some instances, the wavelet may also be considered a Gabor wavelet or complex Morlet wavelet. In one possible implementation, the system may use fixed point arithmetic to generate the impedance spectrum, which may allow for use of relatively lower cost and simpler microcontrollers or other computing platforms more typical of some charging environments where significant computational power is not otherwise necessary.

From the frequency spectrums of the current and voltage signals, the system generates the impedance spectrum (operation 1106). In one example, the impedance spectrum is generated from dividing the voltage spectrum by the current spectrum. More particularly, complex voltage values at various frequencies are divided by complex current values at the same frequencies to generate impedances at the various frequencies. This may generate a complex valued impedance spectrum. In some examples, it is sufficient to limit the generation of an impedance spectrum to a discrete range of frequencies, e.g., 200 HZ to 3 KHZ.

Regardless of the technique, the system generates an impedance spectrum that identifies the impedance of the battery to a particular frequency of a harmonic of a signal applied to the battery. So, in a simplified example, in a square pulse probing signal applied to the battery, there will be a number of harmonics. Through the technique discussed here, the system generates discrete impedances of the battery to some or all of the discrete harmonics in the probe signal. The spectrum, at a generalized level, shows the resistance of the battery to a particular frequency of charge signal. The battery may have more or less impedance (more generally resistance) to different frequency harmonics of the probe signal.

From the impedance spectrum, the system may identify a particular harmonic that is used to define the leading edge of the charge portion of the signal (operation 1108). To determine the shape of the leading edge of the charge signal, the system determines the optimal frequency from the impedance spectrum generated from the probe signal. In one particular example, the optimal frequency is the frequency associated with the lowest impedance (specifically, reactance in some embodiments) in the impedance spectrum. Thus, the system choses the frequency associated with the lowest impedance. It should be appreciated that there may be instances where the system can instead assess admittance, e.g., the highest admittance or the imaginary part of admittance—susceptance. In general, a charge signal applied to the battery with a shape of a frequency associated with a lower impedance will more efficiently transfer energy for charge as compared to frequencies associated with a higher impedance. The optimal frequency is then set as the leading edge of the charge signal or charge portion of the hybrid signal.

Besides the shape of the leading edge of the charge portion, the system also determines the overall attributes of the signals including the length of time of the rest period relative to the charge time (including the shaped portion and the body portion), the overall signal period and other attributes. In one possible example, the period of the charge signal and the rest period are preset and based on battery characterization. The period of the charge signal includes the shaped leading edge and the body portion following the shaped leading edge. In various possible examples, the charging portion may fall in the range of 100 s of microseconds to 10 s of milliseconds. The overall period includes the charging portion and the rest period (or heating portion). The rest period (or heating portion) may fall in the range of 100 s of microseconds to 10 s of microseconds. In other possible examples, the period may fall in the range of 100 s of microseconds to 10 s of milliseconds. A peak current at the peak of the shaped leading edge and the body portion of the charge portion of the cell may be around 20A but the peak current value depends on the cell type, temperature, characterization and other factors and thus may differ significantly from the example peak current. One example of determining charge current, including the peak current is discussed below.

The method of determining the shape of the leading edge may be repeated throughout a heating or charge cycle. In one example, a probe signal and the following operations (1104-1110) are repeated about every ½% to 1% SOC change. In another example, probe signals and the following operations are performed over time, e.g., every 5 seconds, 30 seconds, or 60 seconds. The frequency of probing signals and subsequent operations may change over time. For example, as the cell is heating, the cell may change more quickly and hence the rate of probing etc. may change. As the cell nears a full charge, the rate of probing may also change.

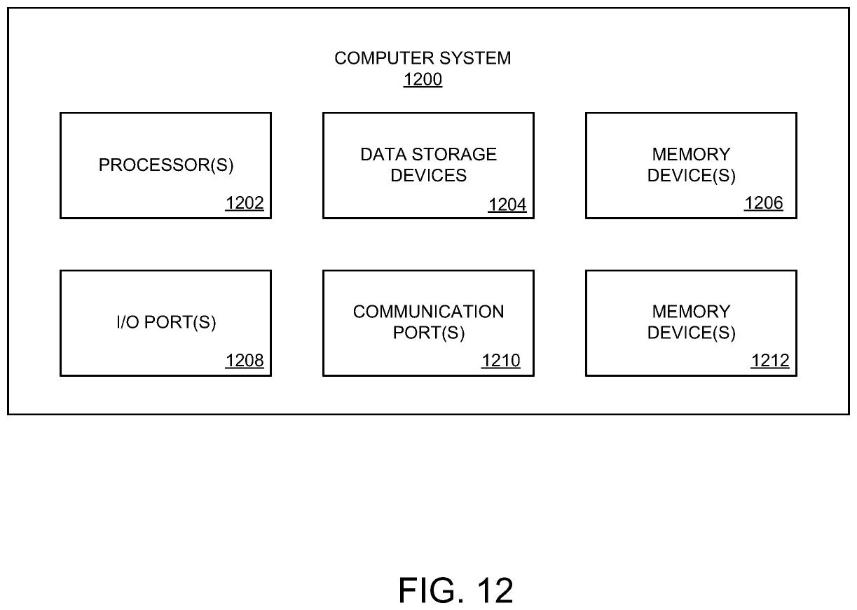

Referring to FIG. 12, a detailed description of an example computing system 1200 having one or more computing units that may implement various systems and methods discussed herein is provided. The computing system 1200 may be part of a controller, may be in operable communication with various implementation discussed herein, may run various operations related to the method discussed herein, may run offline to process various data for characterizing a battery, and may be part of overall systems discussed herein. The computing system 1200 may process various signals discussed herein and/or may provide various signals discussed herein. For example, battery measurement information may be provided to such a computing system 1200. The computing system 1200 may also be applicable to, for example, the controller, the model, the tuning/shaping circuits discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 1200 may be a computing system that may execute a computer program product to execute a computer process. Data and program files may be input to the computer system 1200, which reads the files and executes the programs therein. Some of the elements of the computer system 1200 are shown in FIG. 12, including one or more hardware processors 1202, one or more data storage devices 1204, one or more memory devices 1206, and/or one or more ports 1208-1212. Additionally, other elements that will be recognized by those skilled in the art may be included in the computing system 1200 but are not explicitly depicted in FIG. 12 or discussed further herein. Various elements of the computer system 1200 may communicate with one another by way of one or more communication buses, point-to-point communication paths, or other communication means not explicitly depicted in FIG. 12. Similarly, in various implementations, various elements disclosed in the system may or not be included in any given implementation.

The processor 1202 may include, for example, a central processing unit (CPU), a microprocessor, a microcontroller, a digital signal processor (DSP), and/or one or more internal levels of cache. There may be one or more processors 1202, such that the processor 1202 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 1204, stored on the memory device(s) 1206, and/or communicated via one or more of the ports 1208-1212, thereby transforming the computer system 1200 in FIG. 12 to a special purpose machine for implementing the operations described herein.

The one or more data storage devices 1204 may include any non-volatile data storage device capable of storing data generated or employed within the computing system 1200, such as computer executable instructions for performing a computer process, which may include instructions of both application programs and an operating system (OS) that manages the various components of the computing system 1200. The data storage devices 1204 may include, without limitation, magnetic disk drives, optical disk drives, solid state drives (SSDs), flash drives, and the like. The data storage devices 1204 may include removable data storage media, non-removable data storage media, and/or external storage devices made available via a wired or wireless network architecture with such computer program products, including one or more database management products, web server products, application server products, and/or other additional software components. Examples of non-removable data storage media include internal magnetic hard disks, SSDs, and the like. The one or more memory devices 1206 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1204 and/or the memory devices 1206, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1200 includes one or more ports, such as an input/output (I/O) port 1208, a communication port 1210, and a sub-systems port 1212, for communicating with other computing, network, or vehicle devices. It will be appreciated that the ports 1208-1212 may be combined or separate and that more or fewer ports may be included in the computer system 1200. The I/O port 1208 may be connected to an I/O device, or other device, by which information is input to or output from the computing system 1200. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1200 via the I/O port 1208. In some examples, such inputs may be distinct from the various system and method discussed with regard to the preceding figures. Similarly, the output devices may convert electrical signals received from computing system 1200 via the I/O port 1208 into signals that may be sensed or used by the various methods and system discussed herein. The input device may be an alphanumeric input device, including alphanumeric and other keys for communicating information and/or command selections to the processor 1202 via the I/O port 1208.

The environment transducer devices convert one form of energy or signal into another for input into or output from the computing system 1200 via the I/O port 1208. For example, an electrical signal generated within the computing system 1200 may be converted to another type of signal, and/or vice-versa. In one implementation, the environment transducer devices sense characteristics or aspects of an environment local to or remote from the computing device 1200, such as battery voltage, open circuit battery voltage, charge current, battery temperature, light, sound, temperature, pressure, magnetic field, electric field, chemical properties, and/or the like.

In one implementation, a communication port 1210 may be connected to a network by way of which the computer system 1200 may receive network data useful in executing the methods and systems set out herein as well as transmitting information and network configuration changes determined thereby. For example, charging protocols may be updated, battery measurement or calculation data shared with external system, and the like. The communication port 1210 connects the computer system 1200 to one or more communication interface devices configured to transmit and/or receive information between the computing system 1200 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1210 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means.

The computer system 1200 may include a sub-systems port 1212 for communicating with one or more systems related to a device being charged according to the methods and system described herein to control an operation of the same and/or exchange information between the computer system 1200 and one or more sub-systems of the device. Examples of such sub-systems of a vehicle, include, without limitation, motor controllers and systems, battery control systems, and others.

The system set forth in FIG. 12 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

We claim:

1. A battery charging method comprising:
generating a series of charge signals, each charge signal at a period T and each charge signal including a shaped leading edge and a body portion delivering charge energy to a battery; and
altering a duty cycle of the charge signals to alter an average charge current delivered by the combination of the shaped leading edge and the body portion.

2. The battery charging method of claim 1 further comprising:
shaping the shaped leading edge corresponding to a frequency and an impedance at the battery to the frequency.

3. The battery charging method of claim 1 wherein a maximum current of the charge signals is unaltered when altering the duty cycle of the charge signals to alter the average current.

4. The battery charging method of claim 1 wherein altering the duty cycle is responsive to a battery voltage.

5. The battery charging method of claim 1 wherein altering the duty cycle is responsive to state of charge.

6. The battery charging method of claim 1 wherein altering the duty cycle is responsive to battery temperature.

7. The battery charging method of claim 1 wherein the shaped leading edge and the body portion are followed by a rest period within the period T, the rest period of a lesser maximum current than a maximum current during the body portion.

8. The battery charging method of claim 1 wherein the charge energy is sourced from a capacitor.

9. A method for charging an electrochemical device, the method comprising:
generating a charge signal comprising a shaped leading edge and a body portion delivering charge energy to a battery, the charge signal having a first duty cycle over a signal period T and corresponding to a first average current; and
altering, after a first period of time, the first duty cycle of the charge signal to a second duty cycle over the signal period T, the second duty cycle corresponding to a second average current of the charge signal, the second average current different than the first average current over the signal period T.

10. The method of claim 9 wherein altering the first duty cycle of the charge signal to the second duty cycle causes the second duty cycle to be less than the first duty cycle, the second average current less than the first average current over the signal period T in response to the altering of the first duty cycle.

11. The method of claim 9 wherein altering the first duty cycle of the charge signal to the second duty cycle causes the second duty cycle to be more than the first duty cycle, the second average current more than the first average current over the signal period T in response to the altering of the first duty cycle.

12. The method of claim 9 wherein altering the first duty cycle of the charge signal to the second duty cycle is in response to a voltage of the battery.

13. The method of claim 9 wherein altering the first duty cycle of the charge signal to the second duty cycle is in response to a state of charge of the battery.

14. The method of claim 9 wherein altering the first duty cycle of the charge signal to the second duty cycle is in response to a temperature of the battery.

15. The method of claim 9, further comprising:
altering, after a second period of time, the second duty cycle of the charge signal to a third duty cycle over the signal period T, the third duty cycle corresponding to a third average current of the charge signal.

16. The method of claim 9, further comprising:
maintaining a voltage of the charge signal during the first period of time, the first average current decreasing in response to the maintained voltage of the charge signal.

17. The method of claim 9, further comprising:
altering the charge signal to provide a near zero average current to the battery for a period of time to reduce a temperature of the battery.

18. The method of claim 17 wherein altering the charge signal to provide the near zero average current to the battery is responsive to a temperature of the battery.

19. The method of claim 17 wherein altering the first duty cycle of the charge signal to provide the near zero average current to the battery is responsive to a state of charge of the battery.

20. The method of claim 9, further comprising:
adjusting a duration of the period T, wherein the second average current corresponds to the adjusting of the duration of the period T.

21. The method of claim 9, wherein the shaped leading edge and the body portion are followed by a rest period within the period T, the rest period of a lesser maximum current than a maximum current during the body portion.
